(19) United States
(12) Patent Application Publication
(10) Pub. No.: US 2014/0250465 A1
(43) Pub. Date: Sep. 4, 2014

(54) Systems and Methods for Providing Multiple Versions of Subscription Content and an Option Within One Version to Upgrade to Another

(71) Applicants: James Mulholland, London (GB); Jon Wallace, Middlesex (GB); Dominic Butler, KENT (GB)

(72) Inventors: James Mulholland, London (GB); Jon Wallace, Middlesex (GB); Dominic Butler, KENT (GB)

(73) Assignee: Adobe Systems Incorporated, San Jose, CA (US)

(21) Appl. No.: 12/206,870

(22) Filed: Sep. 9, 2008

(51) Int. Cl. H04N 5/445; G06Q 30/00; G06Q 99/00

(52) U.S. Cl. 725/60

(57) ABSTRACT

Certain embodiments involve providing multiple versions of content to which a user can subscribe and an option within one version that allows a user of that version to upgrade or otherwise switch the subscription to another version of the content. For example, a “GO PREMIUM” command can allow a user to quickly and easily upgrade from within a basic version to a premium version. The premium version may have fewer or no advertisements and/or have additional or improved content. The option itself may identify the benefits. For example, in the case of a premium version that provides additional statistics not provided by a basic version, a button option within the basic version may have text identifying this benefit, e.g., “INTERESTED IN STATISTICS—GO PREMIUM.” As another example, the option may read “TIRED OF ADS—GO PREMIUM!”

### FIELD

Embodiments of the present disclosure relate generally to providing content and advertisements to an electronic device.

### BACKGROUND

Cell phones and other mobile devices offer a variety of mechanisms for accessing remote content. Such devices commonly include Internet browser applications that allow a user to search for and access Internet content. However, this Internet content search and access process can be time consuming since, in many cases, a user is required to search for content or navigate through multiple web pages and there may be latency involved in the connection between the device and the network. In addition, the content is not available when the mobile device is offline; unable to access the Internet. Some devices include applications that retrieve and cache content for a user so that the user does not need to wait for content to download from a remote source and can access the content even when the device is offline.

Adobe® Flash® Cast™ technology is an offline portal that delivers content as an engaging multimedia experience through Flash® mobile applications called channels. Among other things, it facilitates a subscription form of receiving data for one or more channels on a mobile device. A user can subscribe to a channel using a channel browser that lists the channels available to the device, and can access cached content for subscribed-to channels. To facilitate access of such content, the subscribed-to channels may be presented to a user in a channel lineup on a now-playing screen in which the user is able to preview what is playing on the subscribed-to channels and navigate to and select a particular channel in order to then enjoy the channel's multimedia experience. For example, a news channel may allow a user to navigate through and select from a series of news items that have been previously cached to the mobile device from remote servers; each news item including a thumbnail image, a headline, and a related news story. Upon selection of a news item, the corresponding full body text may be shown. Channels can provide static information and/or interactive content, including content having game, messaging, web interface, and a variety of other components.

### SUMMARY

Certain embodiments described herein provide methods and systems for providing multiple versions of content to which a user can subscribe and an option within one version that allows a user of that version to upgrade or otherwise switch the subscription to another version of the content. One exemplary computer implemented method embodiment comprises receiving channel content at an electronic device. The channel content is for channels that are available to the electronic device upon subscription and the channels are used to receive and cache periodically-updated content for the electronic device from one or more channel content providers. The method further comprises providing a navigation area displaying selectable items for a first channel provided to the device under a first subscription. One of the selectable items is a channel upgrade option that, upon selection, activates a second subscription to a second channel. For example, it may be used to upgrade from a first channel offering a basic version of certain content to a premium channel offering a premium version of that content.

In other embodiments, a computer-readable medium (such as, for example, random access memory or a computer disk) comprises code for carrying out these methods.

These embodiments are mentioned not to limit or define the disclosure, but to provide examples of embodiments to aid understanding thereof Embodiments are discussed in the Detailed Description, and further description is provided there. Advantages offered by the various embodiments may be further understood by examining this specification.

### BRIEF DESCRIPTION OF THE FIGURES

These and other features, aspects, and advantages of the present disclosure are better understood when the following Detailed Description is read with reference to the accompanying drawings, wherein:

FIG. 1 is a system diagram illustrating an illustrative network environment according to certain embodiments;

FIG. 2 is an illustration of a mobile device displaying a basic version of a channel, according to certain embodiments;

FIG. 3 is an illustration of the mobile device of FIG. 2 after a user has selected a premium upgrade option, according to certain embodiments;

FIG. 4 is an illustration of the mobile device of FIGS. 2 and 3 displaying a premium version of a channel; and

FIG. 5 is a flow chart illustrating a method of providing multiple versions of subscription content and an option within one version to upgrade to another version, according to certain embodiments.

### DETAILED DESCRIPTION

Certain embodiments involve providing multiple versions of content to which a user can subscribe and an option within one version that allows a user of that version to upgrade or otherwise switch the subscription to another version of the content. For example, a “GO PREMIUM” command can allow a user to quickly and easily upgrade from within a basic version to a premium version. The premium version may have fewer or no advertisements and/or have additional or improved content. The option itself may identify the benefits. For example, in the case of a premium version that provides additional statistics not provided by a basic version, a button option within the basic version may have text identifying this benefit, e.g., “INTERESTED IN STATISTICS—GO PREMIUM.” As another example, the option may read “TIRED OF ADS—GO PREMIUM!”

Different channels may be used to provide different versions of content to an electronic device. A “channel” is a placeholder for cached content on a mobile or other electronic device. Channels may be subscription based; such that a user is able to subscribe to a channel and thereafter have the channel's content available from the device's cache. For example, a mobile device may offer content in one or more channels with some channels providing more than one version of a channel identity, e.g., a basic sports channel and a premium sports channel both related to a “sports” channel identity. Channels providing different versions of a channel identity may provide some of the same content. For example, both a basic sports channel and a premium sports channel may provide the same daily baseball summary content item. The basic channel may be available for free, while the premium channel may require that the recipient provide some form of payment. A basic channel may include extensive advertising and limited content. A premium channel, in contrast may include exclusive content, additional content, higher-quality content, fewer or no advertisements, more frequent updates, or otherwise provide a richer experience that is of value to potential subscribers.

Providing a premium option within a basic channel provides various advantages, including but not limited to, providing a means for a free channel to self-promote a pay version of the channel identity. On mobile devices, screen space may be more limited than on some other electronic devices. On channels having extensive advertisements, including advertisements that may be found within the header image space and throughout content items and navigation pages, advertisements may be presented at the same time a premium option is presented. Thus, a user that does not want to view advertisements may be more likely to elect to upgrade to the premium channel because the option to do so is available at the time the user is viewing the advertisements.

Channel content can be provided in a variety of ways. In one embodiment, the same content is provided for use in multiple channels and the receiving device selectively chooses content/advertisements that will be displayed depending on the subscribed version. Another embodiment involves providing completely separate channels, for example, by providing a basic channel that is separate from and does not share stored content with a premium channel. Such channels may, however, use separately stored copies of the same pieces of content. Content that is common to multiple versions of a channel may thus be cached only a single time on a receiving device or may be cached multiple times, e.g., once for each version of the channel identity having the common content.

### Illustrative Network Configuration

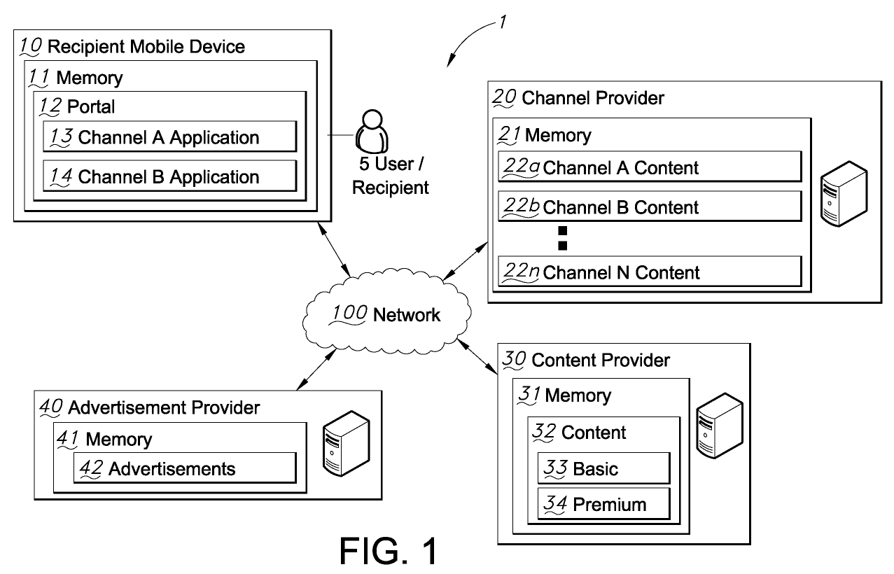

Referring now to the drawings in which like numerals indicate like elements throughout the several Figures, FIG. 1 is a system diagram illustrating an illustrative network environment according to certain embodiments. Other embodiments may be utilized. The environment 1 shown in FIG. 1 comprises a wired or wireless network 100 connecting various network devices 10, 20, 30, 40. Applications that execute on each of the devices 10, 20, 30, 40 are shown as functional or storage components residing in memory 11, 21, 31, 41 on the respective devices. As is known to one of skill in the art, such applications may be resident in any suitable computer-readable medium and execute on any suitable processor. For example, the network devices 10, 20, 30, 40 shown each may comprise a computer-readable medium such as a random access memory (RAM) 11, 21, 31, 41, coupled to a processor that executes computer-executable program instructions stored in memory 11, 21, 31, 41. Such processors may comprise a microprocessor, an ASIC, a state machine, or other processor, and can be any of a number of computer processors. Such processors comprise, or may be in communication with a computer-readable medium which stores instructions that, when executed by the processor, cause the processor to perform the steps described herein.

Recipient mobile device 10 may be used by a mobile device user/recipient 5 to receive content through a channel provider 20 and originating from a content provider 30. The recipient mobile device 10 may also receive advertisements from advertisement provider 40. In this example, recipient mobile device 10 comprises a portal 12 for managing content received for a plurality of channels. Each channel may be controlled by its own application, in this example, channel A application 13 and channel B application 14, and the portal 12 may facilitate navigation amongst different channel applications 13, 14 and within a given channel application 13, 14. For example, the mobile device user 5 may use the portal 12 to select channel A. Once selected, the channel A application 13 may allow the user 5 to preview and select from the content currently playing or otherwise available on Channel A. The channel A application 13 may display items for those currently playing pieces of content in a navigation area and allow the user to navigate through the items to preview and select a desired piece of content. Upon selection of a piece of content from within such a navigation area, the channel A application 13 provides the rest of the piece of content. For example, the navigation area may comprise an image thumbnail and an article title as an item, which, upon selection, provides the remainder of the article.

The content for a channel may be cached on the recipient mobile device 10. For example, a channel application may periodically retrieve content for a channel and store the current content as part of the application within the memory 11 on the recipient mobile device 10. When new content is received for a given channel, the new content can replace some or all of the previously cached content for the channel on the recipient mobile device 10. The recipient mobile device may also cache advertisement content with a channel application 13, 14, within the portal 12, or elsewhere in its memory 11. A channel application 13, 14 may comprise all advertising content.

A channel provider 20 may collect channel content 22 and store such content in memory 20. The channel provider may provide such channel content 22 to subscribers on electronic devices connected at least periodically, for example, through a network 100. A channel provider may comprise more channels than a given electronic device subscribes to and may comprise mechanisms for managing the subscription and access to channel content.

A content provider 30 comprises a memory 31 that stores and distributes content 32 that will be included in a channel's content and ultimately provided to channel subscribers on electronic devices. A content provider 30 can also create, store, and/or provide different versions of content for provision on different channels, for example, a basic version of a channel 33 and a premium version of a channel 34.

An advertisement provider 40 can store and distribute advertisements 42 that will be included in a channel's content and ultimately provided to channel subscribers on electronic devices. A single physical device, logical unit, or business unit can, of course, house one or more channel providers, content providers, and advertisement providers. The components are shown here as single, isolated components for illustrative purposes only.

### Illustrative Subscription Upgrade

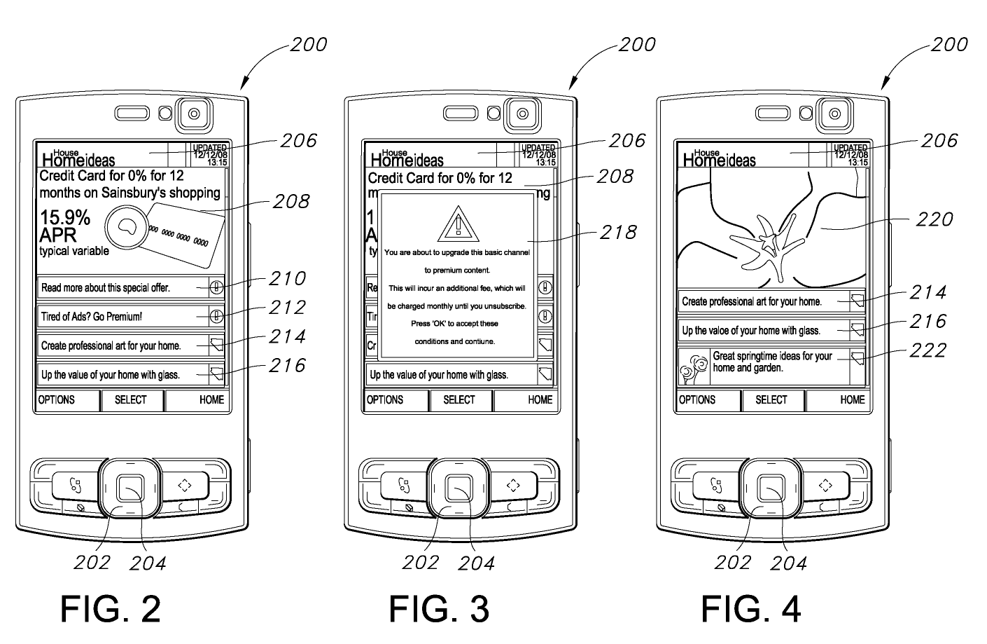

FIGS. 2-4 illustrate the use of an option to upgrade from a basic channel to a premium channel, according to certain embodiments. FIG. 2 is an illustration of a mobile device 200 displaying a basic version of a channel. The displayed channel comprises a title portion 206, an advertisement 208, an advertisement selection option 210, a premium upgrade option 212 that reads “Tired of Ads? Go Premium!”, and content items 214, 216. The channel may also comprise additional content, advertisements, and other selectable and display items that are available by scrolling down on the device 200 within one or more channel navigation pages provided for the channel.

FIG. 3 is an illustration of the mobile device 200 of FIG. 2 after a user has selected the premium upgrade option 212. A notification 218 presented notifies the user that “You are about to upgrade this basic channel to premium content. This will incur an additional fee, which will be charged monthly until you unsubscribe. Press ‘OK’ to accept these conditions and continue.” Upon acceptance and confirmation, the user is unsubscribed from the basic channel and subscribed to the premium channel. Other text or no notification may be displayed. After an upgrade option command is initiated or after it is confirmed, the device may initiate appropriate subscription changes.

FIG. 4 is an illustration of the mobile device 200 of FIGS. 2 and 3 displaying the premium version of a channel. The premium version of the channel comprises the title 206, a content image 220, and content items 214, 216, 222, and potentially other content items or content available by scrolling down within the channel. The content items 214, 216, 222 may be better versions of the content items 214, 216, 222 when provided on the basic channel. For example, such content may be more extensive, more frequently updated, or otherwise provide a richer experience that is of value to potential subscribers. For example, a content item “Great springtime ideas for your home and garden” 222 may be provided on the premium channel but not provided on the basic channel. Similarly, the content image 220 is provided only on the premium channel.

The mobile device 200 also includes a control device 202 for controlling the movement of the focus indicator that identifies which of the items is focused upon. The mobile device 200 further includes a selector device 204. A user can use these physical controls 202, 204 to navigate through interfaces on the mobile device 200 and, in this case, to select the advertisements, content items, and/or the premium upgrade option. As a specific example, a user can press a down command on the control device 202 to move the focus to an item that is beneath a presently focused item. This type of control generally does not allow the user to navigate directly to non-adjacent items, i.e., a user cannot skip items without focusing upon them. In such cases, it may be even more desirable for a user to have the premium version with fewer or no advertisements impeding navigation within a channel experience.

### Illustrative Methods of Providing Multiple Versions of Subscription Content and an Option within One Version to Upgrade to Another Version

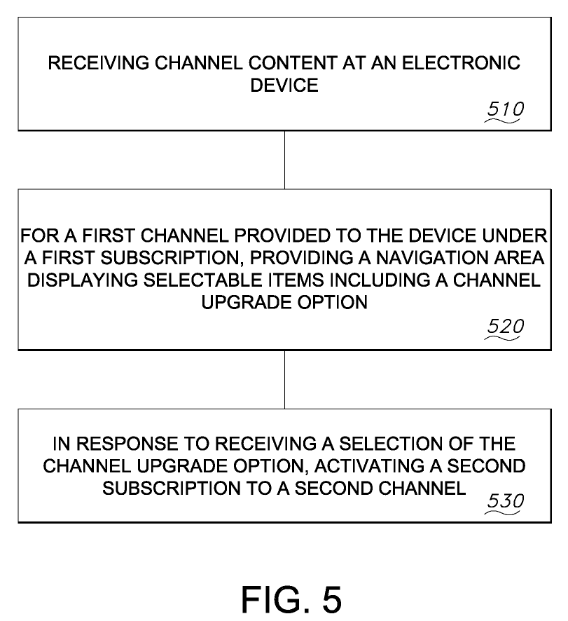

FIG. 5 is a flow chart illustrating a method of providing multiple versions of subscription content and an option within one version to upgrade to another version, according to certain embodiments. For purposes of illustration only, the elements of this method are described with respect to a particular implementation and with respect to exemplary components illustrated in FIG. 1. A variety of other implementations are also possible.

The method shown in FIG. 5 comprises receiving channel content at an electronic device, as shown in block 510. The channel content may comprise media, information, and other types of content that are provided for channels that are available to the electronic device upon subscription. A channel may be used to receive and cache periodically-updated content for the electronic device from one or more channel content providers. An example of an electronic device is the recipient mobile device 10 of FIG. 1. The portal 12 of the recipient mobile device 10 may provide channel applications 13, 14 that allow channel content to be used on the recipient mobile device 10.

The method shown in FIG. 5 further comprises, for a first channel provided to the device under a first subscription, providing a navigation area displaying selectable items including a channel upgrade option, as shown in block 520. The upgrade option may appear as a button, a graphic, text, or any other type of selectable display attribute. An upgrade option may also comprise a description of a benefit of the premium version over the basic version. For example, if the premium content provides additional statistics not provided by the basic version, a button option within the basic version may read “INTERESTED IN STATISTICS—GO PREMIUM.” As another example, the option may read “TIRED OF ADS—GO PREMIUM!” Other selectable items on a given page may comprise content items and advertisement items. For example, a content item may provide a thumbnail image and news headline with a related news story provided when the content item is selected.

The method shown in FIG. 5 further comprises, in response to receiving a selection of the channel upgrade option, activating a second subscription to a second channel, as shown in block 530. The second channel may be an upgraded version of the first channel. For example, the first channel may be a basic version of content and the second channel may be a premium version of that content. The premium version may comprise fewer or no advertisements, additional content not available on the basic version, and/or content that is refreshed or otherwise updated more frequently, as examples. The first and second channels may be provided by a same content provider. For example, as shown in FIG. 1, a single content provider provides both basic content 33 and premium content 34. A subscription fee may be associated with the second channel and may be greater than any subscription fee associated with the first channel. The first channel could be offered at no charge and, for example, be used as a means of encouraging interest in the full or premium channel content of the second channel by providing preview, teaser content, or other initial interest content.

The first subscription for the first channel may be automatically cancelled when the second subscription is activated. The user may be given the option to cancel the first channel at the time of the upgrade. As another alternative, the first channel subscription may remain active giving the recipient the opportunity to remove whichever the recipient chooses at his or her own discretion at a later time.

### Illustrative Methods of Providing Channel Content and Maintaining Channel Subscriptions

Certain embodiments relate to providing channel content and maintaining channel subscriptions. One illustrative method comprises a channel content provider providing first channel content to an electronic device based on a subscription to a first channel. This first channel content comprises selectable items including an upgrade option for upgrading to a second channel that is also provided by the channel content provider. When the channel content provider receives an upgrade request initiated by a selection of the upgrade option on the electronic device, it modifies its channel subscription information. The channel content provider may maintain channel subscription information for the first channel and the second channel. In response to receiving an upgrade request, the channel content provider can modify the channel subscription information to indicate activation of a new subscription to the second channel. Upon activation of the second channel, the channel content provider can provide content for the second channel to the requester. The channel content provider may also modifying the channel subscription information to indicate cancellation of the subscription to the first channel.

In certain embodiments, channel subscriptions may be associated with a user account. In response to receiving an upgrade request, appropriate changes can be made to a user account. For example, upon receiving an upgrade option, a content provider may identify an account associated with the request, which is typically an account associated with the subscription to the first channel from which the update request was made. Once the user account has been identified, the content provider may modify the user account information associated with the subscription to the first channel to reflect the new subscription to the second channel and/or reflect cancellation of the subscription to the first channel.

In certain embodiments, channel subscriptions and upgrades are monitored, maintained, or otherwise managed by an entity or device other than a content provider. In certain embodiments, channel subscription and upgrade information is stored on a third party device and/or on a content consuming device. In certain embodiments, a subscription account is associated with a device rather than a user or with a particular user/device combination. A variety of alternative implementations are also within the scope of the present disclosure.

### General

Certain embodiments relate to the basic and premium channels provided on mobile devices. These are merely illustrative and the techniques described herein have uses in other embodiments, including on a variety of different television and computing devices. In short, the techniques for providing content and the other features described herein have uses in a variety of contexts, not to be limited by the specific illustrations provided herein. It should also be noted that embodiments may comprise systems having different architecture and information flows than those shown in the Figures. The systems shown are merely illustrative and are not intended to indicate that any system component, feature, or information flow is essential or necessary to any embodiment or limiting the scope of the present disclosure. The foregoing description of the embodiments has been presented only for the purpose of illustration and description and is not intended to be exhaustive or to limit the disclosure to the precise forms disclosed. Numerous modifications and adaptations are apparent to those skilled in the art without departing from the spirit and scope of the disclosure.

In addition, with respect to the computer implementations depicted in the Figures and described herein, certain details, known to those of skill in the art have been omitted. For example, software tools and applications that execute on each of the devices and functions performed thereon are shown as functional or storage components on the respective devices. As is known to one of skill in the art, such applications may be resident in any suitable computer-readable medium and execute on any suitable processor. For example, computing and media consuming devices each may comprise a computer-readable medium such as a random access memory (RAM), coupled to a processor that executes computer-executable program instructions stored in memory. Such processors may comprise a microprocessor, an ASIC, a state machine, or other processor, and can be any of a number of computer processors. Such processors comprise, or may be in communication with a computer-readable medium which stores instructions that, when executed by the processor, cause the processor to perform the steps described herein.

A computer-readable medium may comprise, but is not limited to, an electronic, optical, magnetic, or other storage or transmission device capable of providing a processor with computer-readable instructions. Other examples comprise, but are not limited to, a floppy disk, CD-ROM, DVD, magnetic disk, memory chip, ROM, RAM, an ASIC, a configured processor, optical storage, magnetic tape or other magnetic storage, or any other medium from which a computer processor can read instructions. A computer-readable medium may transmit or carry instructions to a computer, including a router, private or public network, or other transmission device or channel, both wired and wireless. The instructions may comprise code from any suitable computer-programming language, including, for example, C, C++, C#, Visual Basic, Java, Python, Perl, JavaScript, and Adobe® Actionscript.

While the network 100 may comprise the Internet, in other embodiments, other networks, such as an intranet, or no network may be used. Moreover, methods may operate within a single device. Devices can be connected to a network 100 as shown. Alternative configurations are of course possible. The devices may also comprise a number of external or internal devices such as a mouse, a CD-ROM, DVD, a keyboard, a remote control, a display, or other input or output devices. Examples of devices are personal computers, digital assistants, personal digital assistants, cellular phones, mobile phones, smart phones, pagers, digital tablets, laptop computers, Internet appliances, other processor-based devices, and television viewing devices. In general, a device may be any type of processor-based platform that operates on any operating system capable of supporting one or more client applications or media content consuming programs.

1. A computer implemented method comprising:
receiving channel content at an electronic device, the channel content for channels available to the electronic device upon subscription and used to receive and cache periodically-updated content for the electronic device;
providing a navigation area displaying selectable items for a first channel, at least some of the selectable items previewing and, upon selection, providing pieces of content currently available on the first channel, where the pieces of content that are currently available change based upon periodically-updated content received for the first channel, the periodically-updated content of the first channel provided to the electronic device under a first subscription, wherein a selectable item of the selectable items comprises an upgrade option; and
in response to receiving a selection of the upgrade option, sending an activation request to activate a second subscription to a second channel.

2. The computer implemented method of claim 1, wherein the second channel is an upgraded version of the first channel.

3. The computer implemented method of claim 1, wherein the first channel is a basic version of content and the second channel is a premium version of the content.

4. The computer implemented method of claim 3 wherein the premium version comprises fewer advertisements.

5. The computer implemented method of claim 3, wherein the premium version comprises no advertisements.

6. The computer implemented method of claim 3, wherein the premium channel comprises additional content not available on the basic version.

7. The computer implemented method of claim 3, wherein content is updated more frequently to the second channel than to the first channel.

8. The computer implemented method of claim 3, wherein a subscription fee associated with the second channel is greater than a subscription fee associated with the first channel.

9. The computer implemented method of claim 3, wherein there is a subscription fee associated with the second channel and the first channel is provided at no charge.

10. The computer implemented method of claim 3, wherein the upgrade option comprises a description of a benefit of the premium version over the basic version.

11. The computer implemented method of claim 1 further comprising, in response to receiving the selection of the upgrade option, sending a cancel request to cancel the first subscription.

12. The computer implemented method of claim 11, wherein the activation request and cancel request are combined in a single, combined request.

13. The computer implemented method of claim 1, wherein another selectable item of the selectable items comprises a selectable advertisement item.

14. The computer implemented method of claim 1, wherein the electronic device is a mobile device.

15. The computer implemented method of claim 1, wherein periodically-updated content cached on the electronic device for the first channel is also provided to the second channel.

16. The computer implemented method of claim 1 further comprising caching periodically-updated content for the first channel, wherein the periodically-updated content for the first channel is not used for the second channel.

17. The computer implemented method of claim 1, wherein the channel content provider provides periodically-updated content for the first channel and periodically updated content for the second channel.

18. A computer implemented method comprising:
providing first channel content to an electronic device based on a subscription to a first channel, wherein the first channel content comprises selectable items, at least some of the selectable items previewing and, upon selection, providing pieces of content currently available on the first channel, where the pieces of content that are currently available change based upon periodically-updated content for the first channel, a selectable item of the selectable items comprising an upgrade option for upgrading to a second channel;
receiving an upgrade request from the electronic device, the upgrade request initiated by a selection of the upgrade option on the electronic device;
maintaining channel subscription information for the first channel and the second channel, and, in response to receiving the upgrade request, modifying the channel subscription information to indicate activation of a new subscription to the second channel; and
sending second channel content to the electronic device based on the new subscription to the second channel.

19. The computer implemented method of claim 18 further comprising, in response to receiving the upgrade request, modifying the channel subscription information to indicate cancellation of the subscription to the first channel.

20. The computer implemented method of claim 18 further comprising, in response to receiving the upgrade request, identifying a user account associated with the subscription to the first channel and modifying the user account associated with the subscription to the first channel to reflect the new subscription to the second channel.

21. The computer implemented method of claim 20 further comprising modifying the user account associated with the subscription to the first channel to reflect cancellation of the subscription to the first channel.

22. An electronic device system comprising:
a channel receiving module for receiving channels, the channels available to the electronic device upon subscription and used to receive and cache periodically-updated content for the electronic device;
a channel viewing module for displaying channel content and providing a navigation area displaying selectable items, at least some of the selectable items previewing and, upon selection, providing pieces of content currently available on the first channel, where the pieces of content that are currently available change based upon periodically-updated content received for the first channel, wherein a selectable item of the selectable items comprises an upgrade option; and
an upgrade module for responding to a selection of the upgrade option by sending a request to activate a second subscription to a second channel, the first channel comprising a channel displayed by the channel viewing module when the selection of the upgrade option is received and the second channel comprising an upgraded version of the first channel.

23. The electronic device system of claim 22, wherein the second channel comprises fewer advertisements, more content, or more frequently updated content than the first channel.

24. The electronic device system of claim 22, wherein a subscription fee associated with the second channel is greater than a subscription fee associated with the first channel.

25. The electronic device system of claim 22, wherein there is a subscription fee associated with the second channel and the first channel is free.

26. The electronic device system of claim 22, wherein the upgrade option comprises a description of a benefit of the second channel over the first channel.

27. The electronic device system of claim 22, wherein the electronic device is a mobile device.

28. A non-transitory computer-readable medium on which is encoded program code, the program code comprising:
program code for receiving channel content at an electronic device, the channel content for channels available to the electronic device upon subscription and used to receive and cache periodically-updated content for the electronic device;
program code for providing a navigation area displaying selectable items for a first channel, at least some of the selectable items previewing and, upon selection, providing pieces of content currently available on the first channel, where the pieces of content that are currently available change based upon periodically-updated content received for the first channel, the periodically-updated content of the first channel provided to the electronic device under a first subscription, wherein a selectable item of the selectable items comprises an upgrade option; and
program code for in response to receiving a selection of the upgrade option, sending an activation request to activate a second subscription to a second channel.

29. The computer implemented method of claim 1, wherein the selectable items allow selection from content currently available on the first channel, wherein, in response to a selection of a first selectable item of the selectable items, content associated with the first selectable item is displayed.

30. The computer implemented method of claim 29, wherein the first selectable item comprises a portion of the content associated with the first selectable item, wherein, in response to a selection of the first selectable item, a remaining portion of the content associated with the first selectable item is displayed.

31. The computer implemented method of claim 30, wherein the portion of the content associated with the first selectable item comprises a thumbnail image and a title of an article, wherein the remaining portion comprises a remaining portion of the article.

32. The computer implemented method of claim 1, wherein providing a navigation area displaying selectable items for a first channel comprises simultaneously displaying an advertisement and the upgrade option.
